(19) United States
(12) Patent Application Publication
(10) Pub. No.: US 2016/0189072 A1
(43) Pub. Date: Jun. 30, 2016

(54) OPERATION-PLAN SCHEDULING DEVICE AND ITS METHOD

(71) Applicant: KABUSHIKI KAISHA TOSHIBA, Minato-ku (JP)

(72) Inventors: Yusuke KUROKI, Yokohama (JP); Shigeta KUNINOBU, Yokohama (JP)

(73) Assignee: KABUSHIKI KAISHA TOSHIBA, Minato-ku (JP)

(21) Appl. No.: 15/066,368

(22) Filed: Mar. 10, 2016

Related U.S. Application Data
(63) Continuation of application No. PCT/JP2014/072331, filed on Aug. 26, 2014.

(30) Foreign Application Priority Data
Sep. 20, 2013 (JP) 2013-196086

(51) Int. Cl. G06Q 10/06; G06Q 30/02; G06F 17/30

(52) U.S. Cl. CPC G06Q 10/06314; G06F 17/30958; G06Q 30/0283

(57) ABSTRACT

A new operation is added to an operation plan while reducing the change amount in switch costs before and after change. An operation-plan scheduling device according to one embodiment is provided with a reader to read an operation plan, switch-cost information, information of an additional operation; a graph-network creator to create a graph network by setting intervals between operations allocated to the operation executors as an interval vertices, connecting edges among an entry vertex, an interval vertex, and an exit vertex, and setting weight variables on the edges; a path selector to select a path based on edge weight sums of the paths from the entry vertex to the exit vertex of the graph network; and an operation-plan creator to exchange operations between the operation executors in accordance with the selected path and allocate the additional operation to the interval created by the exchange.

### CROSS REFERENCE TO RELATED APPLICATIONS

This application is a Continuation of International Application No. PCT/2014/072331, filed on Aug. 26, 2014, the entire contents of which is hereby incorporated by reference.

### FIELD

Embodiments of the present invention relates to an operation-plan scheduling device and its method in factories, deliveries, service provision, etc.

### BACKGROUND

Scheduling of an operation plan having a large number of operations has been carried out by using a so-called greedy algorithm because of restrictions of the calculation time allowed to be used for scheduling. For example, scheduling has been carried out by picking up operations using a simple index such as the order of tighter deadlines and allocating them to an operation executor which can finish the operations most quickly while avoiding the already-allocated operations.

On the other hand, as performance evaluation of schedules, it has been required to simultaneously improve multiple indices such as adherence to deadlines, minimizing of switch costs between operations as a whole, maximizing of the work rate (operation density) of operation executors, and minimizing of operation work periods (Turn Around Time).

However, with an algorithm at a level of the above described greedy algorithm, it is difficult to improve these indices with sufficient considerations. For example, in a case in which operations are to be allocated to operation executors in the order of tighter deadlines, if a policy of not changing the once-allocated operations is taken, the time without operation remains like uneven patterns in the operation executors, and the work rates of the operation executors cannot be improved. If the operations to be allocated from now are only allowed to be allocated after the other already-allocated operations, unnecessary delays are generated.

### BRIEF DESCRIPTION OF THE DRAWINGS

FIG. 1 is a block diagram of an operation-plan scheduling device according to the first embodiment;

FIG. 2 is a drawing showing an example of a data storage according to the first embodiment;

FIG. 3 is a drawing showing constituent elements of a graph network according to the first embodiment;

FIG. 4 is a drawing showing an example of an operation plan according to the first embodiment;

FIG. 5 is a drawing showing an example of the graph network according to the first embodiment;

FIGS. 6A to 6C are explanatory drawings of actions of an operation-plan creator according to the first embodiment;

FIG. 7 is a flow chart of the actions according to the first embodiment;

FIG. 8 is a block diagram of an operation-plan scheduling device according to the second embodiment;

FIG. 9 is a drawing showing an example of a data storage according to the second embodiment;

FIG. 10 is a drawing showing an example of an operation plan according to the second embodiment;

FIG. 11 is a drawing showing examples of graph networks according to the second embodiment;

FIG. 12 is a flow chart of actions according to the second embodiment; and

FIG. 13 is an explanatory drawing of the third embodiment.

### DETAILED DESCRIPTION

The embodiments of the present invention provide an operation-plan scheduling device and its method which enable addition of a new operation(s) to an operation plan while reducing the variation amount (increase amount) of the total switch costs.

An operation-plan scheduling device according to one embodiment includes a computer which includes a processor. The operation-plan scheduling device includes a reader, a graph-network creator, a path selector and an operation-plan creator implemented by the computer, respectively.

The reader reads an operation plan allocating multiple operations to multiple operation executors, information of switch costs for each ordered pair of two operations which are made when the operation executor switches the operations, and information of an additional operation having start time and one of process time or end time.

The graph-network creator creates a graph network. The graph-network creator sets interval vertices corresponding intervals of time between the operations allocated to the operation executors, connects an edge from the interval vertex corresponding to the one of the intervals to the interval vertex corresponding to the other interval when the intervals intersect with each other and end time of the former intervals is earlier than end time of the latter interval. The graph-network creator connects an edge from an entry vertex to the interval vertices corresponding to the intervals, when the start time of the additional operation is included in the intervals. The graph-network creator connects an edge to an exit vertex from the interval vertices corresponding to the intervals including the end time of the additional operation or the intervals thereafter.

The graph-network creator sets an edge weight on the edge, the edge weight based on the switch costs between the operations before and after the interval for the tail of the edge, between the operations before and after the interval for the head of the edge, and between the operation before the interval for the head and the operation after the interval for the tail. The graph-network creator sets an edge weight on the edge connected from the entry vertex to the interval vertex, the edge weight based on the switch costs between the operations before and after the interval corresponding to the interval vertex and between the operation before the interval and the additional operation. The graph-network creator sets an edge weight on the edge connected from the interval vertex to the exit vertex, the edge weight based on the switch costs between the operations before and after the interval corresponding to the interval vertex and between the additional operation and the operation after the interval.

The path selector selects a path from multiple paths from the entry vertex to the exit vertex in the graph network, based on the edge-weight sum of each path.

The operation-plan creator generates an interval having a length equal to or more than the process time of the additional operation for the operation executor belonging to the interval corresponding to the interval vertex next to the entry vertex and allocate the additional operation to the generated interval to update the operation plan.

The operation-plan creator generates the new interval with enough length to insert the additional operation by tracking the interval vertices after the next interval vertex of the entry vertex in the selected path, and repeating to replace all the following operations after the interval corresponding to the next interval vertex with all the following operations after the interval corresponding to the tracked interval vertex each time, and insert the additional operation to the new interval.

Hereinafter, embodiment of the present invention will be explained with reference to drawings.

### FIRST EMBODIMENT

The present embodiment will be explained by an example of creating a production-plan schedule of a factory as scheduling of an operation plan. In this case, “operation executors” are devices, and “operation” is a unit such as a lot which is desired to be allocated to the device without dividing the operation. The “operation” will be hereinafter referred to as “Work”. It is assumed that the device can process only one Work at a time. The plurality of the devices is assumed.

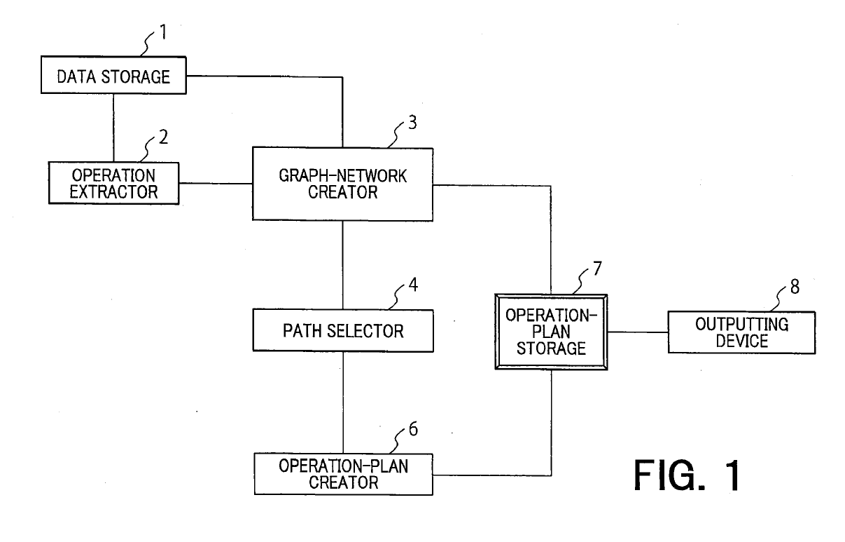

FIG. 1 is a block diagram of an operation-plan scheduling device according to the embodiment of the present invention.

The operation-plan scheduling device of FIG. 1 is provided with a data storage 1, an operation extractor 2, a graph-network creator 3, a path selector 4, an operation-plan creator 6, an operation-plan storage 7, and an outputting device 8.

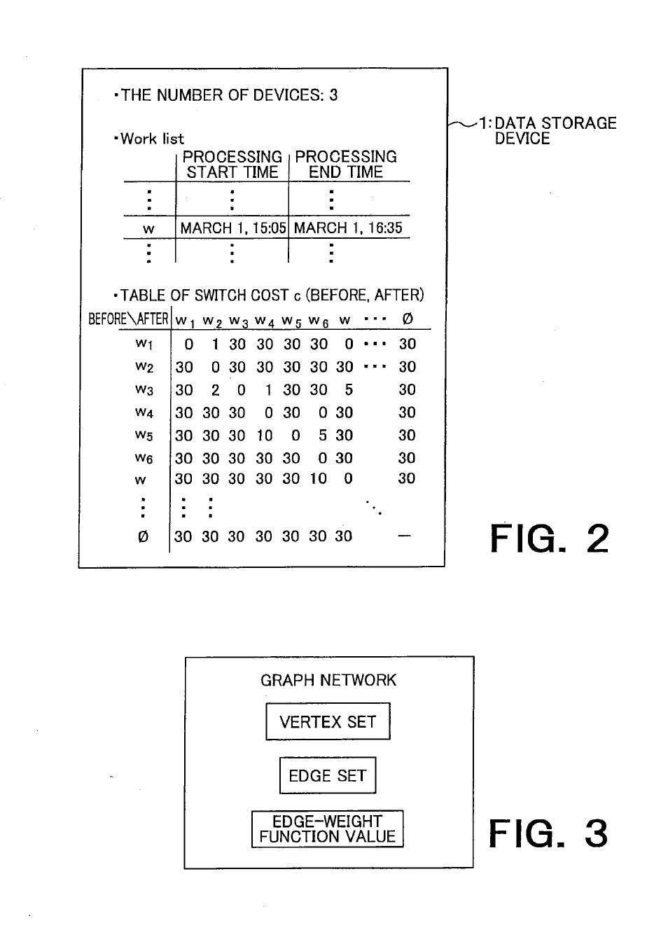

The data storage 1 stores the number of devices, an operation list, and a switch-cost table. FIG. 2 shows an example of the data storage 1. The number of the devices is the number of the devices which can process operations and is three in the example shown in the drawing. The operation list is a list of Works serving as targets of an operation plan. Processing start time and processing end time of each Work is determined. It is assumed that the operation plan has been already fixed for Works “w₁”to “w₆”, and a situation of adding a Work “w” to this created operation plan is assumed. Allocation-finished flags may be attached to the allocation-finished Works. The Work “w” shown in the drawing is representing an arbitrary one unallocated Work. The Work “w” is required to start operation at the processing start time and finish it at the processing end time. The devices have the same performance, and, if each of the devices starts processing of “w” from the processing start time, the processing can be finished at the processing end time shown in the drawing. In other words, each of the devices can process “w” by the duration of (“the processing end time”-“the processing start time”. The switch costs are the costs required to switch “Works”. The switch costs from “wᵢ” to “wⱼ” are described as “c(wᵢ, wⱼ)”. If a certain device processes a Work “w₁” and then processes “w₂”, switch costs “c(w₁, w₂)” from “w₁” to “w₂” shown in the drawing are taken 1, and the costs “c(w₁, w₆)” of a case of switching “w₁” to “w₆” is 30. Also, the costs “c(w₁, w)” of switching “w₁” to “w” are 0. “Cost” is a value which can be converted to expenditure, time, etc. “Φ” (empty set) shown in the drawing represents that there is no Work.

The operation-plan storage 7 is storing a completed operation plan(s) or an in-process operation plan(s). The in-process operation plan is a plan in a state in which an unallocated operation(s) is remaining, and the completed operation plan is an operation plan in a state in which all operations have been allocated. The operation plan includes the information of the processing start time, the processing end time, and an allocation-destination device(s) of the already-allocated Work(s).

FIG. 4 shows an example of an operation plan in a state in which there are devices “m₁”, “m₂”, and “m₃”, and Works “w₁”, “w₂”, “w₃”, “w₄”, “w₅”, and “w₆” are allocated. The operation plan of FIG. 4 is an in-process operation plan. This includes the information of processing start time, processing end time, and allocation-destination devices of the already-allocated Works “w₁” to “w₆”. In the present embodiment, a case in which a new Work “w” (see FIG. 2) is to be allocated to this operation plan is assumed.

The operation extractor 2 selects a Work (additional operation), which is to be allocated next, from the data storage 1 in some way. In the explanation hereinafter, this selected Work will be referred to as “w”. As described above, the data storage 1 is retaining the processing start time and the processing end time about “w”. The device which can process “w” between the processing start time and the processing end time has to be found out to carry out allocation.

The graph-network creator 3 reads the information of the Work “w”, the existing operation plan stored in the operation-plan storage 7, and the switch-cost table stored in the data storage 1 and creates a graph network. The graph-network creator 3 is provided with a reader which reads the data. FIG. 5 shows an example of the graph network created from the operation plan of FIG. 4 and the Work “w” and the switch-cost table of FIG. 2.

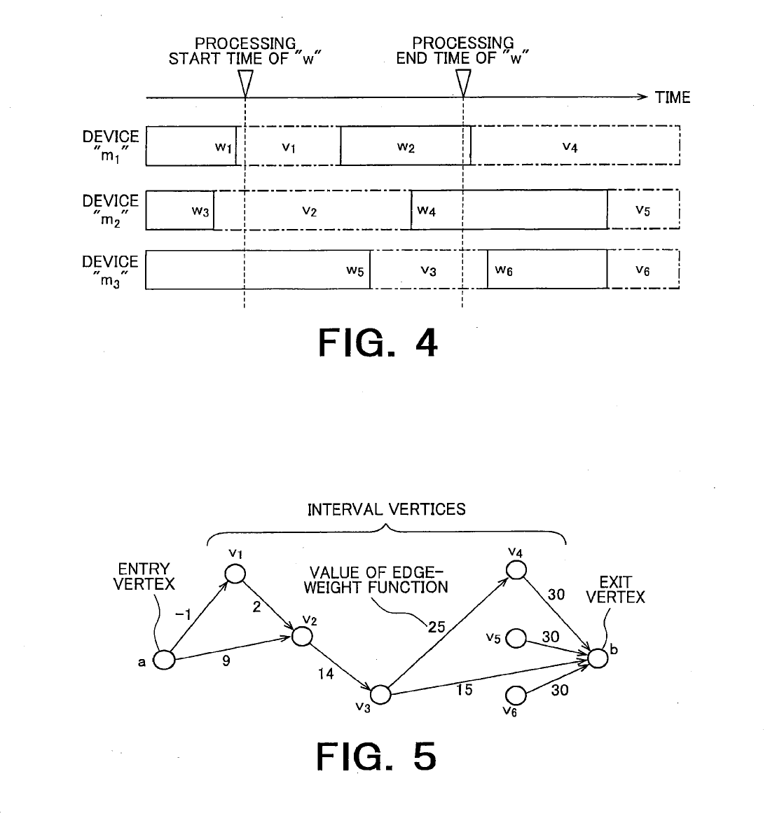

As shown in FIG. 3, the graph network includes a vertex set, an edge set, and an edge-weight function value(s) (edge weight). Note that those consisting only of a vertex set and an edge set is sometimes referred to as a graph network.

The vertex set includes vertices (referred to as interval vertices) corresponding to intervals between Works of the existing operation plan and a special entry vertex “a” and exit vertex “b”, which are different from the interval vertices.

If conditions (interval conditions) that an intersection “rᵢ” corresponding to an interval vertex “vᵢ” and an interval “rⱼ” corresponding to an intersection vertex “vⱼ” intersect with each other as intervals and that the end time of “rᵢ” is smaller than the end time of “rⱼ” are satisfied, an edge is connected from “vᵢ” to “vⱼ”.

‘The intervals “rᵢ” and “rⱼ” intersect with each other as intervals’ means that [“end time of rᵢ”≧“start time of rⱼ”] and [“start time of rᵢ”≦“end time of rⱼ”] are satisfied.

In the example of the work plan shown in FIG. 4, an interval “r₁” corresponding to an interval vertex “v₁” and an interval “r₂” corresponding to an interval vertex “v₂” intersect with each other as intervals, and the end time of “r₁” is smaller than the end time of “r₂”; therefore, an edge is connected from “v₁” to “v₂”.

Edges are connected from the entry vertex “a” to the interval vertices corresponding to the intervals including the processing start time of “w” serving as an allocation target. In the example of FIG. 4, the edges are connected from “a” to “v₁” and “v₂”, respectively.

Moreover, edges are connected from the interval vertices, which are corresponding to the intervals including or after the processing end time of “w” serving as the allocation target, to the exit vertex. In the example of FIG. 4, edges are connected from “v₃”, “v₄”, “v₅”, and “v₆” to “b”, respectively.

A set of the edges connected between the intervals which satisfy the interval conditions, the edges connected from the entry vertex, and the edges connected to the exit conditions in the above described manner is the edge set.

Now, the vertices and the edges were fixed, and then weights will be given on the edges of the graph network. Before explaining edge weight setting, let us introduce the meaning of the graph network simply. A graph network can have 0 or more paths from an entry vertex to an exit vertex. Each of the paths corresponds to a replacement (replacement of unprocessed time) procedure of operations among devices for creating longer unprocessed time to which a Work is to be allocated. When replacement of an operation which is after an interval corresponding to a vertex next to an entry vertex of one path with all operations which are after the interval of the tracked vertex every time the vertex thereafter is tracked is repeated until it reaches an exit vertex, an interval of a Work-allocatable time is created for the device having the Work in the interval corresponding to the vertex next to the entry vertex; therefore, the Work is allocated to the interval, and the operation plan is updated. If the number of the path(s) is “0”, it means that the Work cannot be allocated.

The edge weight is calculated in accordance with an edge-weight function. The edge-weight function is provided in advance. The edge weight is calculated by using the switch costs.

The edge from the interval vertex “v₁” to “v₂” is taken as an example to explain the edge weight. The edge-weight value of the edge from “v₁” to “v₂” is defined as “2c(w₃, w₂)−c(w₁, w₂)−c(w₃, w₄)” by an edge-weight function. It is obtained as “2×2−1−1=2” by using the values of the switch-cost table of FIG. 2. In other words, the edge weight based on the switch costs between the operations (w₁, w₂) before/after the interval of the interval vertex in the start point edge of the edge, between the operations (w₃, w₄) before/after the interval in the end point edge of the edge, and between the operation before the interval of the edge-head and the operation after the interval of the edge-tail (w₃, w₂) is set on the edge.

The edge from “v₁” to “v₂” means to replace all of the Works after “v₁” (in other words, all the following Works from “w₂”) with all the Works after “v₂” (in other words, all the following Works from “w₄”). The value which assumes a case of carrying out such replacement and is based on variations in the switch costs before/after the replacement is the edge weight. The switch costs “c(w₁, w₂)” and “c(w₃, w₄)” before the replacement are present, and “c(w₃, w₂)” and “c(w₁, w₄)” can present after switching. However, if the edge from “v₁” to “v₂” is tracked, as described later, the entry vertex “a” to “v₁” is tracked before, and, since this means a case in which the time in the interval of “v₁” is allocated to “w”, “c(w₁, w₄)” is not generated after the replacement. Therefore, in evaluation after the replacement, “c(w₁, w₄)” does not serve as a target. Therefore, the switch-cost difference before/after the replacement is provided as “2c(w₃, w₂)−c(w₁, w₂)−c(w₃, w₄)” as an edge weight.

While using parameters “α” (≠0) and “k” as variables, the edge-weight value of the edge from “v₁” to “v₂” could be “α[2c(w₃, w₂)−(2−k) c(w₁, w₂)−k c(w₃, w₄)]”. The present example corresponds to a case in which the parameter “α” is 1 and “k” is 1. Alternatively, while using the parameter “α=½” and “k=1”, it can be also evaluated as “c(w₃, w₂)−c(w₁, w₂)/2−c(w₃, w₄)/2”.

Also about the edges between other interval vertices, the edge weights are similarly calculated. For example, the edge weight from “v₂” to “v₃” uses “(α=1, k=1)” which results in “2c(w₅, w₄)−c(w₃, w₄)−(w₅, w₅)”. Alternatively, it may be “c(w₅, w₄)−c(w₃, w₄)/2−(w₅, w₆)/2” with the parameter “α=½” and “k=1”.

Moreover, the weight of the edge connected from the entry vertex “a” is obtained. Herein, the entry vertex “a” and the interval vertex “v₁” are taken as examples. The edge-weight value from “a” to “v₁” is assumed to be “2c(w₁, w)−c(w₁, w₂)”by an edge-weight function. This is obtained as “2'0−1=−1” by using the switch-cost table of FIG. 2. In other words, with respect to the edge connected from the entry vertex “a” to the interval vertex “v₁”, the edge weight based on the switch costs between the operations (w₁, w₂) before/after the intervals corresponding to the interval vertex “v₁” and between the operation before the interval and the additional operation (w₁, w) is set.

Tracking from the entry vertex “a” to “v₁” is to allocate the time in the interval of “v₁” to “w” as described above; wherein, it is conceivable that “c(w₁, w₂)” is present before change and “c(w₁, w)” and “c(w, w₂)” is present after change. However, “c(w₁, w₂)” may not be present because of the replacement after “w₂”. Therefore, “c(w₁, w₂)” does not serve as a target. Therefore, the edge weight for evaluating the switch-cost variation before/after the replacement is “2c(w₁, w)−c(w₁, w₂)”.

As well as the edge connected between the interval vertices, the edge-weight value of the edge from “a” to “v₁” could be “α[2c(w₁, w₂)−k c(w₁, w₂)]” while using the parameters “α” (≠0) and “k”. The present example corresponds to the case in which the parameter “α” is 1 and “k” is 1. Alternatively, it can be evaluated as “c(w₁, w)−c(w₁, w₂)/2” while using the parameter “α=½” and “k=1”.

Herein, if a case of “α=½” and “k=1” is taken into consideration, since “−c(w₁, w₂)/2” is included in the edge weight for the edge connecting from “v₁” to “v₂”, “−c(w₁, w₂)/2” appears twice, and addition thereof results in “−c(w₁, w₂)”. If “w” is allocated to the device “m₁”, “c(w₁, w₂)” is not generated; therefore, if a replacement operation is carried out by the path through this edge and if the switch-cost variation of the operation plan before/after update is to be evaluated, the term “−c(w₁, w₂)” appears. In the present weight function, this “−c(w₁, w₂)” is shared by the two edges “(a→v₁ and v₁→v₂)”.

Moreover, the weight of the edge connected to the exit vertex “b” is also obtained. Herein, the interval vertex “v₃” and the exit vertex “b” are taken as examples. The edge-weight value of the edge from “v₃” to “b” is assumed to be “2c(w, w₆)−c(w₅, w₆)”. This is obtained as “2×10−5=15” by using the switch-cost table of FIG. 2. With respect to the edge connected from the interval vertex “v₃” to the exit vertex “b”, an edge weight based on the switch costs between the operations (w₅, w₆) before/after the interval of the interval vertex “v₃” and between the additional operation and the operation after the interval (w, w₆).

As well as the edge connected between the intervals, the edge-weight value of the edge from “v3” to “b” could be “α[2c(w, w₆)−(2−k) c(w₅, w₆)]” while using the parameters “α” (≠0) and “k”. The present example corresponds to a case in which the parameter “α” is 1 and “k” is 1. Alternatively, it can be evaluated as “c(w, w₆)−c(w₅, w₆)/2” while using the parameters “α=½” and “k=1”.

Note that, if the parameter “α=½” and “k=1” are taken into consideration, “−c(w₅, w₆)/2” appears twice since “−c(w₅, w₆)/2” appears also in the edge weight of the edge from “v₂” to “v₃”, and addition thereof results in “−c(w₅, w₆)”. In other words, “−c(w₅, w₆)” is shared by the two edges (the switch costs from “w₅” to “w₆” are not generated in the operation plan after replacement by this path.).

The path selector 4 obtains one shortest path in which the sum of the edge weights from the entry vertex to the exit vertex is minimum. Methods of obtaining the shortest path are widely studied in a graph algorithm field, and they can be used (IRI, et al.: “Practical Graph Theory”, CORONA PUBLISHING CO., LTD, 1983, pp. 88-96). Most simply, all the path patterns from the entry vertex to the exit vertex are listed, the sum of the edge weights is calculated for each of the path patterns, and the path pattern in which the sum of the edge weights is minimum can be obtained as the shortest path. In the example of FIG. 5, a vertex sequence of “(a, v₁, v₂, v₃, b)” is obtained. If there are multiple paths in which the sum of the edge weights are minimum, one of them can be selected by an arbitrary method. As a variant, instead of the one in which the sum of the edge weights is minimum, a path that is equal to or less than a threshold value may be selected. For example in a case in which the number of paths is large, there is an advantage that calculation time can be shortened by cancelling calculation when the path that is equal to or less than the threshold value is found.

Based on the obtained shortest path, the operation-plan creator 6 moves the already-allocated Work(s) between the devices and allocates “w” to the device. A method thereof will be explained by using an example.

When the shortest path of the vertex sequence “(a, v₁, v₂, v₃, b)” is obtained, the device to which “w” is to be allocated is the device “m₁” to which “v₁” belongs. This is for a reason that the interval vertex next to the entry vertex is “v₁”. Then, a vacant interval (vacant time) which allows insertion of “w” after “w₁” has to be created. A way of creating the vacant interval is as described below.

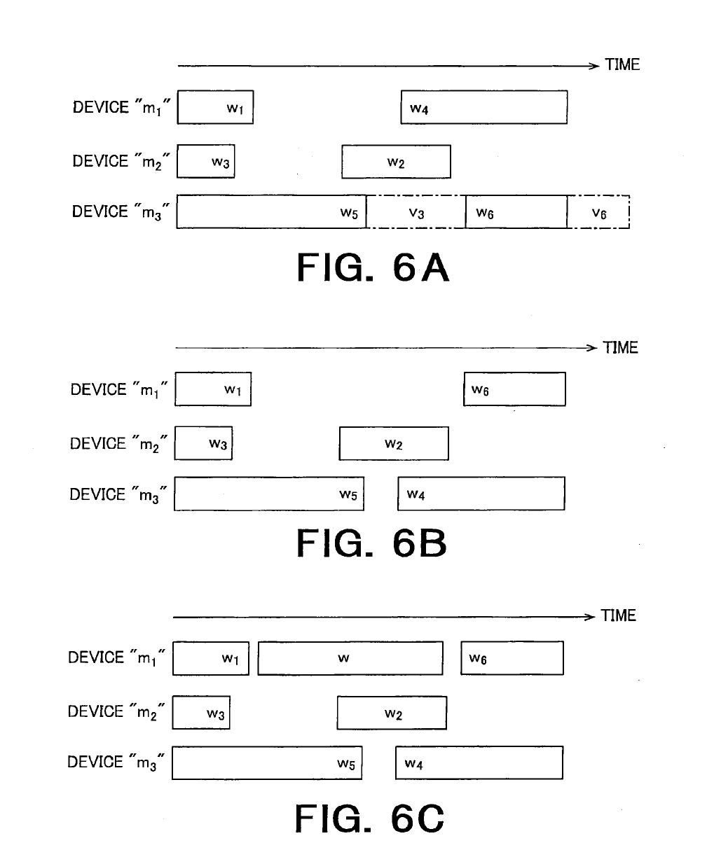

First, since the interval vertex next to “v₁” is “v₂”, all the Works after “v₁” (in other words, all the following Works from “w₂”) and all the Works after “v₂” (in other words, all the following Works after “w₄”) are replaced with each other. A state at this point is shown in FIG. 6A. As a result, an interval after the end time of the interval “v₁” in the interval “v₂” is created in the device “m₁” as an additional vacant interval.

Next, the interval vertex next to “v₂” is “v₃”. Also the next time, all the Works after “v₂” and all the Works after “v₃” are replaced with each other. Since the interval representing “v₂” has already been eliminated, a manipulation carried out herein is to replace all the following works from “w₄” moved from the device “m₂” to the device “m₁” (in other words, all the following Works after “v₂” in the original state) and all the following Works after “v₃” (in other words, all the following Works from “w₆”) are replaced with each other. The state at this point is shown in FIG. 6B. Thus, the interval from the end time of the additional vacant interval, which has been created before in the device “m₁” to the end time of “v₃” is continuously newly added to the device “m₁”.

If the replacement operation corresponding to the edges between the interval vertices in the shortest path is finished in this manner, the vacant interval to be allocated to “w” is created in the device “m₁”. Therefore, as shown in FIG. 6C, “w” is inserted in this vacant interval.

The operation-plan storage 7 saves the state of this new operation plan created by the operation-plan creator 6. If a Work to be extracted by the operation extractor 2 is still present, the operation extractor 2 selects the next Work and carries out the above described process, thereby adding the next Work to the above described new operation plan.

If the Work to be extracted by the operation extractor 2 does not exist, the outputting device 8 outputs the operation plan stored in the operation-plan storage 7. For example, the operation plan may be displayed on a display device, may be transmitted to a terminal owned by a user by wire or by wirelessly, or may be output by a printer.

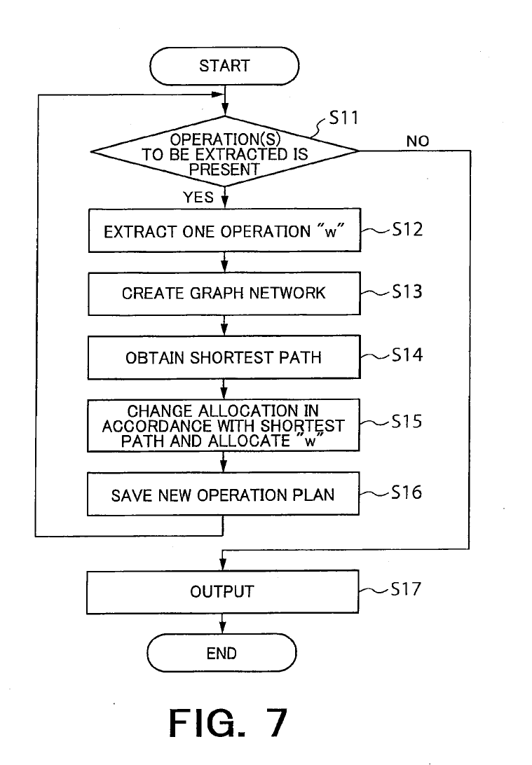

FIG. 7 is a flow chart of actions according to the first embodiment.

The operation extractor 2 judges whether an operation(s) to be extracted (additional operation) is remaining in the operation list in the data storage 1 or not (S11). If it is not remaining, the outputting device 8 outputs the operation plan in the operation-plan storage 7 to finish the present actions.

If the operation(s) is remaining, the operation extractor 2 extracts one operation “w” (S12), and the graph-network creator 3 creates a graph network based on the information of the extracted operation “w”, the switch-cost table, and the current operation plan stored in the operation-plan storage 7 (S13). The path selector 4 selects one path from the graph network. For example, the path in which the sum of the edge weights is the smallest or the path in which the sum is equal to or less than a threshold value is selected (S14).

In accordance with the path selected by the path selector 4, the operation-plan creator 6 changes allocation of the operations between the devices (between the operation executors) to create vacant time (interval) for adding the operation “w” and allocates the operation “w” to the interval (S15). The operation plan is updated by this, and the updated operation plan (new operation plan) is saved in the operation-plan storage 7 (S16).

Hereinabove, the embodiment of the present invention focuses on the vacant time and the switch costs, creates the graph network, which determines the weights of the edges on the graph network by the values based on change amounts of the switch costs, finds the shortest path on the graph network, and (partially) changes the once-determined schedule according to the shortest path. In the shortest path obtained in the above description, the change amount of the switch costs is minimum (as a creation method of the graph network, setting of the values of the edge-weight functions is technical). As a result, a better schedule can be made by (partially) changing the once-determined schedule. In other words, the operation desired to be allocated now can be allocated by ensuring longer vacant time by allocating the once-allocated operation(s) to the other device(s), and the sum of the new operation switch costs generated by the allocation to the other device(s) in this process can be minimized.

### SECOND EMBODIMENT

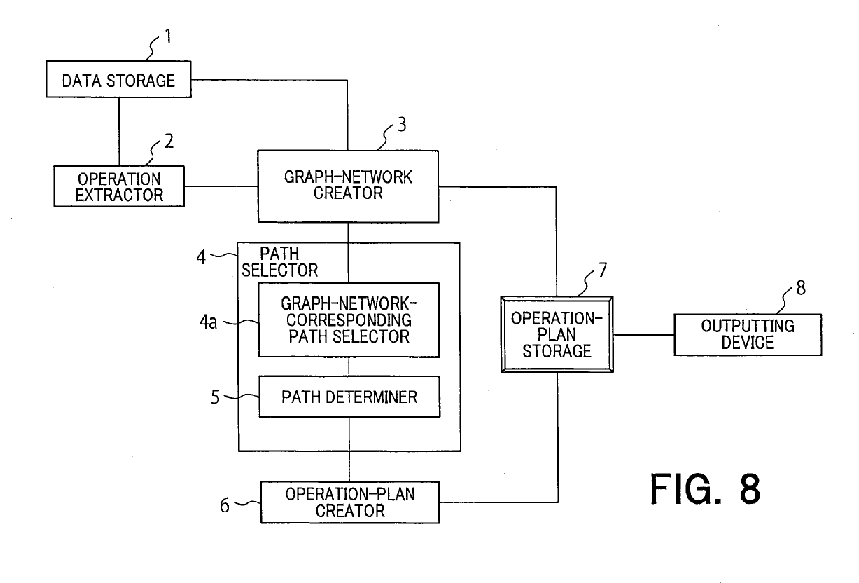

FIG. 8 is a block diagram of an operation-plan scheduling device according to an embodiment of the present invention.

The operation-plan scheduling device of FIG. 8 is provided with the data storage 1, the operation extractor 2, the graph-network creator 3, the path selector 4, the operation-plan creator 6, the operation-plan storage 7, and the outputting device 8. The path selector 4 has a graph-network-corresponding path selector 4a and a path determiner 5. The elements which are equivalent parts of FIG. 1 are denoted by the same reference signs, and, except for extended or changed processes, redundant explanations will be omitted. Hereinafter, differences from the first embodiment will be mainly explained.

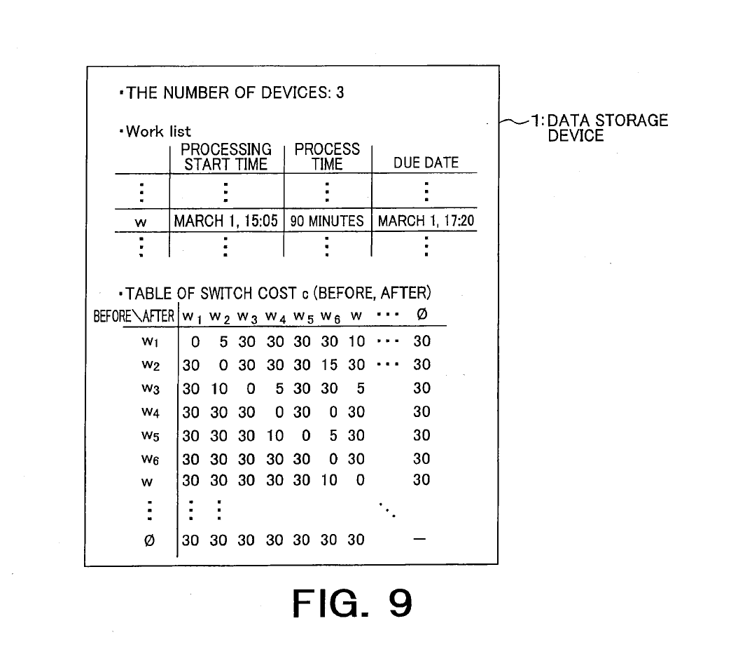

FIG. 9 shows an example of information stored in the data storage 1. Different from the first embodiment, release time, process time, and a due date are retained about the Work “w”. In the present embodiment, the device that starts from the release time or thereafter, carries out processing that takes time by the process time, and finishes the processing until the due date is found, and the Work “w” is allocated thereto. Note that the due date is to be kept as much as possible.

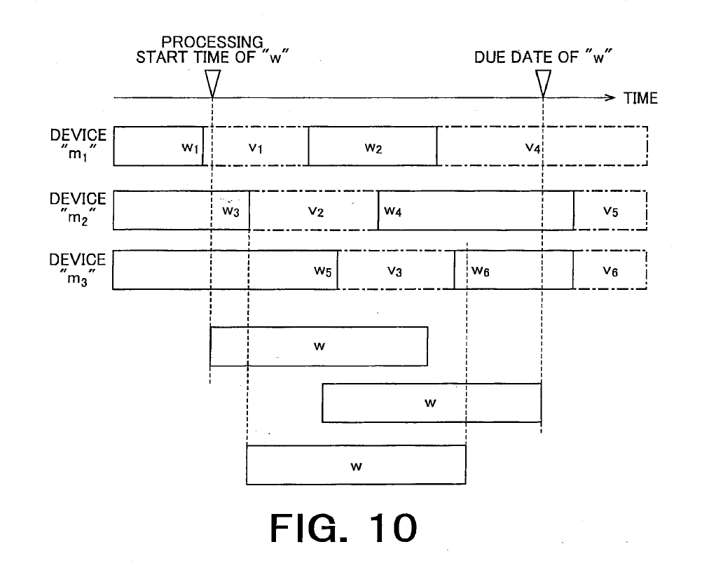

FIG. 10 shows an example of an operation plan. The present embodiment will be explained by taking a case in which a Work “w” is to be newly allocated to the operation plan of FIG. 10 as an example. In the operation plan of FIG. 10, the devices “m₁”, “m₂”, and “m₃” are present, and Works “w₁”, “w₂”, “w₃”, “w₄”, “w₅”, and “w₆” have already been allocated.

The graph-network creator 3 creates a graph network from the information of the Work “w”, the switch-cost table stored in the data storage 1, and the existing operation plan stored in the operation-plan storage 7. In the present embodiment, different from the first embodiment, time “t” which is a deadline for starting in order to finish the process until the due date is obtained. If the process can be started from the release time until “t”, the due date can be met. In other words, in the present embodiment, there are multiple candidates of the start time.

In the example of FIG. 10, if processing can be started from interval of “v₁” or “v₂”, the due date can be met. Note that, since troubles can be handled when the processing is started as early as possible, the processing is started from the release time if it can be inserted in the interval “v₁” and is started from the start time of “v₂” if it is inserted in the interval “v₂”.

Then, if it is inserted in “v₁”, it can be finished in any of the intervals of “v₃”, “v₄”, “v₅”, and “v₆”; however, if the processing is started from the start time of “v₂”, since the processing cannot be finished in the interval of “v₃”, it has to be finished in any of the intervals of “v₄”, “v₅”, and “v₆”.

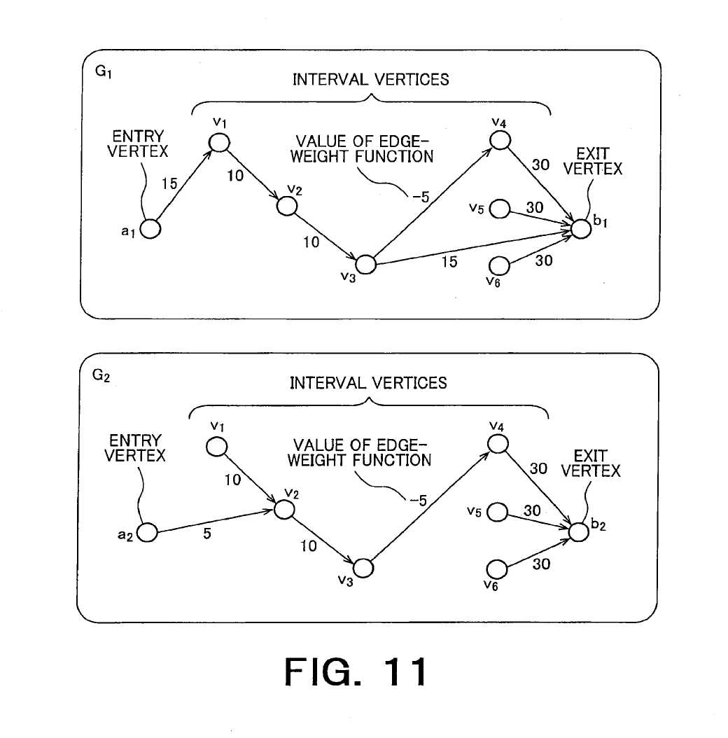

In order to realize this, in the present embodiment, graph networks are created respectively for the vertices of the intervals to start the processing. The graph network in which the processing is started from the interval “v₁” is named “G₁”; wherein an entry vertex is named “a₁”, and an exit vertex is named “b₁”. Similarly, the graph network in which the processing is started from the interval “v₂” is named “G₂”; wherein an entry vertex is named “a₂”, and an exit vertex is named “b₂”. FIG. 11 shows the graph networks “G₁” and “G₂” created by the graph-network creator 3. The graph networks “G₁” and “G₂” may be created completely separately from each other, or the graph network “G₂” may be created by copying the graph network “G₁” and modifying only changed parts.

The graph network “G₂” is taken as an example to explain a way of connecting an edge between the entry vertex and an interval vertex, a way of connecting an edge between interval vertices, a way of connecting an edge between an interval vertex and the exit vertex, and edge weights. Basic concepts are similar to the first embodiment.

Since the operation “w” is started from the interval of “v₂”, an edge is connected from the entry vertex “a₂” to the vertex of “v₂”. The edge-weight value of this edge becomes “2c(w₃, w)−c(w₃, w₄)” in the example of FIG. 11. This is obtained as “2×5−5=5” by using the switch-cost table of FIG. 10.

The time at which “w” finishes processing is obtained from the time from which it can be started earliest in “v₂”, and edges are connected to the exit vertex from the interval vertices which include the time or are corresponding to intervals thereafter. In the example of FIG. 11, edges are connected respectively from “v₄”, “v₅”, and “v₆” to “b₂”. The edge-weight value is also determined; wherein, the interval vertex “v₄” and the exit vertex “b₂” are taken as an example herein. The edge-weight value of the edge from “v₄” to “b₂” is assumed to be “2c(w, Φ)−c(w₂, Φ)”. Herein, “Φ” (empty set) represents that there is no Work. This is obtained as “2×30−30=30” by using the switch-cost table of FIG. 9.

Note that the way of connecting the edge between the interval vertices and the calculation of the edge weight are similar to the first embodiment. For example, the edge-weight value of the edge from “v₁” to “v₂” is defined as “2c(w₃, w₂)-c(wᵢ, w₂)−c(w₃, w₄)”. This is obtained as “10×2−5=10” by using the values of FIG. 10.

Note that, as well as the first embodiment, the edge weights set by the graph-network creator 3 have the degrees of freedom as below. While using “α” (≠0) and “k” as variables, the edge-weight value of the edge from “v₁” to “v₂” could be “α[2c(w₃, w₂)−(2−k) c(w₁, w₂)−k c(w₃, w₄)]”, the edge-weight value of the edge from “a₁” to “v₁” could be “α[2c(w₁, w)−k c(w₁, w₂)]”, and the edge-weight value of the edge from “v₃” to “b₁” could be “α[2c(w, w₆)−(2−k) c(w₅, w₆)]”.

With respect to each of the graph networks, the graph-network-corresponding path selector 4a obtains the shortest path in which the sum of the edge weights from the entry vertex to the exit vertex is minimum. The methods of obtaining the shortest paths are widely studied in the graph algorithm field, and they can be used (IRI, et al.: “Practical Graph Theory”, CORONA PUBLISHING CO., LTD, 1983, pp. 88-96). In the example of the graph “G2” of FIG. 11, a vertex sequence “(a₂, v₂, v₃, v₄, b₂)” is obtained. If there is no path that reaches the exit vertex from the entry vertex, “w” cannot be added. The path determiner 5 determines one shortest path from the shortest paths, which are obtained from the graph networks, by some criterion. For example, in the example of FIG. 11, the shortest paths having the sum “50” of the edge weights of the shortest path and the sum “40” are obtained from the graph network “G₁” and “G₂”, respectively. The shortest path of the graph network “G₂” is advantageous in order to reduce the sum of the switch costs. On the other hand, in view of the processing start time, the shortest path of the graph network “G₁” is advantageous in a point that it can be started early. Which shortest path is to be determined can be specified in advance by the intention of a user in the present device.

Based on the shortest path determined by the path determiner 5, the operation-plan creator 6 moves the already-allocated Works between the devices and allocates “w” to the device. As a result, the existing operation plan is updated. The method thereof is similar to the first embodiment.

The operation-plan storage 7 saves the operation plan updated by the operation-plan creator 6.

If there is no more Work to be extracted by the operation extractor 2, the outputting device 8 outputs the operation plan, which is stored in the operation-plan storage 7, by a method determined in advance. Examples of the output are similar to the first embodiment.

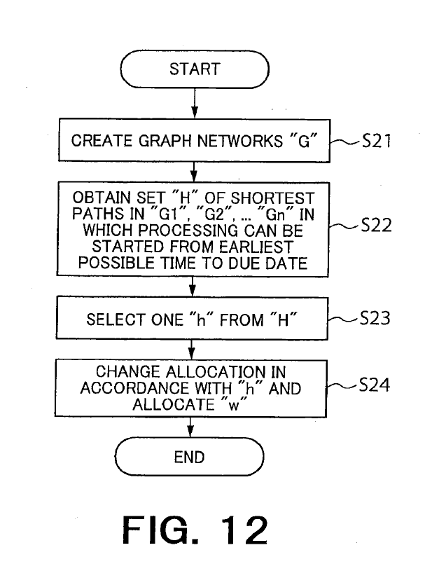

FIG. 12 is a flow chart of actions according to the second embodiment.

As well as the first embodiment, the operation extractor 2 judges whether an operation(s) to be extracted (additional operation) is remaining in the operation list in the data storage 1 or not. If not remaining, the outputting device 8 outputs the operation plan in the operation-plan storage 7 to finish the present actions. If the operation(s) is remaining, the operation extractor 2 extracts one operation “w”, and the graph-network creator 3 creates graph networks based on the information of the extracted operation “w”, the switch-cost table, and the current operation plan stored in the operation-plan storage 7 (S21).

In this step S21, first, the time “t” which is the deadline for starting so that “w” finishes processing until the due date is obtained. If the processing can be started from the release time to “t”, the due date can be met. All of the intervals from which the processing can be started are specified. The graph networks are created respectively for the vertices of the intervals in which the processing is started. If the number of the intervals in which the processing can be started is “n”, “n” graph networks G₁, G₂, . . . , Gₙ, are created (S21).

The graph-network-corresponding path selector 4a selects one path, for example, shortest path from each of the graph networks. The set of the selected shortest path is assumed to be a set “H” (S22). The path determiner 5 determines one shortest path “h” from the set “H” (S23). The operation-plan creator 6 creates vacant time by changing allocation of operations between the devices in accordance with the shortest path “H” and allocates the operation “w” to the created vacant time. The operation plan is updated by this, and the updated operation plan (new operation plan) is saved in the operation-plan storage 7.

Hereinabove, according to the present embodiment, the plurality of shortest paths can be obtained in accordance with the possibilities of the operation start time, and an appropriate shortest path can be selected therefrom and scheduled in accordance with an index other than the minimum change amount of switch costs.

### THIRD EMBODIMENT

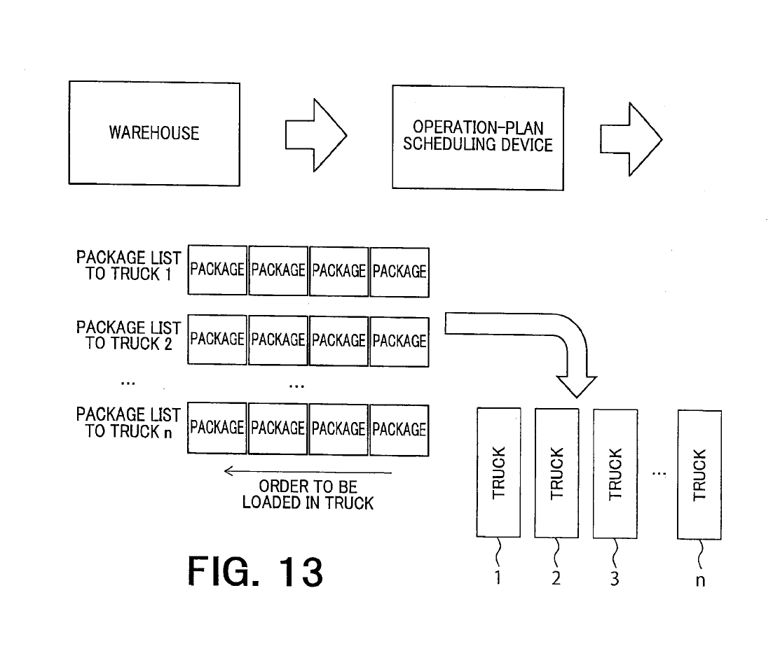

In the present embodiment, as a specific application example of the first embodiment, an example of application to a delivery plan is shown. More specifically, the first embodiment is applied to a problem of sending packages (gatherings of baggage) in a warehouse to a delivery destination from the warehouse by using multiple trucks. FIG. 13 shows a drawing for explaining the present embodiment.

In the warehouse, the baggage to be delivered is gathered. Packages in which the baggage of close delivery time zones, close delivery-destination baggage, and the same-temperature specification are gathered are created. The packages (gatherings of baggage) have three types of temperature settings “cool”, “frozen”, and “normal temperature” which have to be maintained in delivery, and a truck can set only any of “cool”, “frozen”, and “normal temperature” at a time.

Changing the set temperature of the truck takes labor such as manpower, and labor values are determined respectively for “cool→frozen”, “cool→normal temperature”, “frozen→cool”, “normal temperature→cool”, “frozen normal temperature”, and “normal temperature→frozen”. This is called switch costs.

Moreover, the single track can be loaded with only one package. The information of the delivery destination is tagged to the packages, and the time from delivery until return to the warehouse is determined.

A problem to delivery which package by which truck in a case in which the time to start delivering the packages and the time to finish delivery is determined is desired to be solved. In this case, the delivery is replaced by “operation, the packages are replaced by “Works”, and the devices are replaced by “trucks”, and the operation extractor 2, the graph-network creator 3, the path selector 4, the operation-plan creator 6, the operation-plan storage 7, and the outputting device 8 of the first embodiment are operated in the manner of the above described first embodiment. As a result, in the case in which the time to start delivering the packages and the time to finish the delivery is determined the problem of delivering which package by which truck can be solved.

The scheduling device in each embodiment as described above may also be realized using a general-purpose computer device as basic hardware. That is, each function block in the scheduling device can be realized by causing a processor mounted in the above general-purpose computer device to execute a program. In this case, the scheduling device may be realized by installing the above described program in the computer device beforehand or may be realized by storing the program in a storage medium such as a CD-ROM or distributing the above described program over a network and installing this program in the computer device as appropriate. Furthermore, the storage in the scheduling device may also be realized using a memory device or hard disk incorporated in or externally added to the above described computer device or a storage medium such as CD-R, CD-RW, DVD-RAM, DVD-R as appropriate.

The present invention is not limited to the above described embodiments as they are, and constituent elements can be substantiated with deformation within a range not deviating from the gist thereof in a practical phase. Various inventions can be formed by appropriate combinations of the plurality of constituent elements disclosed in the above described embodiments. For example, some constituent elements can be deleted from all the constituent elements shown in the embodiments, and the elements across the different embodiments can be appropriately combined.

1. An operation-plan scheduling device comprising a computer including a processor, comprising:
a reader implemented by the computer to read an operation plan allocating plural operations to plural operation executors, information of switch costs depending on the operations before and after switching is made in a case in which the operation executor switches the operations, and information of an additional operation having start time and one of process time and end time;
a graph-network creator implemented by the computer to create a graph network,
setting interval vertices corresponding intervals of time between the operations allocated to the operation executors ,
connecting an edge from the interval vertex corresponding to the one of the intervals to the interval vertex corresponding to the other interval when between the operation executors, the intervals intersect with each other and end time of the one of the intervals is earlier than end time of the other interval,
connecting an edge from an entry vertex to the interval vertex corresponding to the interval, when the start time of the additional operation is included in the interval, connecting an edge from the interval including the end time of the additional operation or from the interval vertex corresponding to the interval thereafter to an exit vertex,
setting an edge weight on the edge, the edge weight based on the switch costs between the operations before and after the interval in the tail of the edge, between the operations before and after the interval in the head of the edge, and between the operation before the interval in the head and the operation after the interval in the tail,
setting an edge weight on the edge connected from the entry vertex to the interval vertex, the edge weight based on the switch costs between the operations before and after the interval corresponding to the interval vertex and between the operation before the interval and the additional operation, and
setting an edge weight on the edge connected from the interval vertex to the exit vertex, the edge weight based on the switch costs between the operations before and after the interval corresponding .to the interval vertex and between the additional operation and the operation after the interval;
a path selector implemented by the computer to select a path from plural paths from the entry vertex to the exit vertex in the graph network, based on an edge-weight sum of each path; and
an operation-plan creator implemented by the computer to generate an interval having a length equal to or more than the process time of the additional operation for the operation executor belonging to the interval corresponding to the interval vertex next to the entry vertex and allocate the additional operation to the generated interval to update the operation plan wherein the operation-plan creator generates the interval by tracking the interval vertices after the next interval vertex of the entry vertex in the selected path and repeating to replace all the following operations after the interval corresponding to the next interval vertex with all the following operations after the interval corresponding to the tracked interval vertex each time the following interval vertex is tracked.

2. The device according to claim 1, wherein
the path selector selects a path in which the edge weight sum is minimum or is equal to or less than a threshold value.

3. The device according to claim 1, wherein
plural candidates of the start time are present;
the graph-network creator creates the graph networks for candidates of the interval at which processing of the additional operation is stated, each interval candidate including at least any of the candidates of the start time, and sets, from the entry vertex, the edge only to the interval vertex corresponding to the interval candidate in each of the graph networks; and
the path selector selects the paths in the graph networks and determines one path from the paths.

4. The device according to claim 3, wherein
the path selector determines the one path based on at least either one of comparing the sum of the switch costs among the paths and comparing the start times of the candidates among the paths.

5. An operation-plan scheduling method performed by a computer, comprising:
reading-in an operation plan allocating plural operations to plural operation executors, information of switch costs depending on the operations before and after switching is made in a case in which the operation executor switches the operations, and information of an additional operation having start time and one of process time and end time;
creating a graph network as the following processing:
setting interval vertices corresponding intervals of time between the operations allocated to the operation executors ,
connecting an edge from the interval vertex corresponding to the one of the intervals to the interval vertex corresponding to the other interval when between the operation executors, the intervals intersect with each other and end time of the one of the intervals is earlier than end time of the other interval,
connecting an edge from an entry vertex to the interval vertex corresponding to the interval, when the start time of the additional operation is included in the interval,
connecting an edge from the interval including the end time of the additional operation or from the interval vertex corresponding to the interval thereafter to an exit vertex,
setting an edge weight on the edge, the edge weight based on the switch costs between the operations before and after the interval in a start point side of the edge, between the operations before and after the interval in an end point side of the edge, and between the operation before the interval in the end point side and the operation after the interval in the start point side,
setting an edge weight on the edge connected from the entry vertex to the interval vertex, the edge weight based on the switch costs between the operations before and after the interval corresponding to the interval vertex and between the operation before the interval and the additional operation, and
setting an edge weight on the edge connected from the interval vertex to the exit vertex, the edge weight based on the switch costs between the operations before and after the interval corresponding to the interval vertex and between the additional operation and the operation after the interval;
selecting a path from plural paths from the entry vertex to the exit vertex in the graph network, based on an edge-weight sum of each path; and
generating an interval having a length equal to or more than the process time of the additional operation for the operation executor belonging to the interval corresponding to the interval vertex next to the entry vertex and allocate the additional operation to the generated interval to update the operation plan wherein the generating an interval includes tracking the interval vertices after the next interval vertex of the entry vertex in the selected path and repeating to replace all the following operations after the interval corresponding to the next interval vertex with all the following operations after the interval corresponding to the tracked interval vertex each time the following interval vertex is tracked.
